(19) United States
(12) Patent Application Publication
(10) Pub. No.: US 2024/0172318 A1
(43) Pub. Date: May 23, 2024

(54) UPDATING A TRANSMISSION CONFIGURATION INDICATOR (TCI) STATE OR CHANGING A PATH LOSS REFERENCE SIGNAL (PL-RS) BASED ON A REFERENCE SIGNAL RECEIVED WITHIN A THRESHOLD TIME PERIOD

(71) Applicant: QUALCOMM Incorporated, San Diego, CA (US)

(72) Inventors: Tianyang Bai, Mountain View, CA (US); Yan Zhou, San Diego, CA (US); Fang Yuan, Beijing (CN); Tao Luo, San Diego, CA (US); Junyi Li, Fairless Hills, PA (US); Sony Akkarakaran, Poway, CA (US); Jelena Damnjanovic, Del Mar, CA (US); Mostafa Khoshnevisan, San Diego, CA (US)

(21) Appl. No.: 18/551,519

(22) PCT Filed: May 11, 2021
(86) PCT No.: PCT/CN2021/092995

§ 371 Date: Sep. 20, 2023

(51) Int. Cl. H04W 76/20; H04B 7/06; H04L 5/00; H04W 24/10

(52) U.S. Cl. CPC H04W 76/20; H04B 7/06968; H04L 5/0051; H04W 24/10

(57) ABSTRACT

The present disclosure provides systems, apparatus, methods, and computer-readable media for reducing latency associated with performing some operations that use a reference signal. To illustrate, a user equipment (UE) may receive a reference signal and then may receive a message indicating one or more of an update of a transmission configuration indicator (TCI) state of the UE or a change in designation of a path loss reference signal (PL-RS) measured by the UE. If the reference signal is received within a threshold time period of receiving the message (or vice versa), the UE may perform the update or the change in designation of the PL-RS using one or more parameters determined using the reference signal.

### TECHNICAL FIELD

Aspects of the present disclosure relate generally to wireless communication systems, and more particularly, to use of reference signals within wireless communication systems.

### DESCRIPTION OF THE RELATED TECHNOLOGY

Wireless communication systems are widely deployed to provide various types of communication content such as voice, video, packet data, messaging, broadcast, and so on. A wireless multiple-access communication system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Some wireless communication systems use reference signals to compensate for characteristics within the wireless communication systems, such as noise or interference. To illustrate, a base station may transmit a reference signal, such as a channel state information reference signal (CSI-RS) or a synchronization signal block (SSB). A UE may receive the reference signal and may determine one or more parameters based on the reference signal (such as by measuring the reference signal).

The UE may use the one or more parameters to transmit or receive one or more other transmissions. For example, the base station may indicate that the reference signal has a quasi-colocation (QCL) relation with the one or more other transmissions, which may indicate that the reference signal and the one or more other transmissions share one or more properties. In this case, the UE may use the one or more parameters determined based on the reference signal for the one or more transmissions, which may improve reliability of communication. Receiving and measuring reference signals consumes processing cycles and power, which may reduce battery life of a UE.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method for wireless communication performed by a user equipment (UE). The method includes receiving a reference signal and receiving a message within a threshold time period after receiving the reference signal. The message indicates an update to a target transmission configuration indicator (TCI) state for the UE or indicates that the UE is to use the reference signal as a path loss reference signal (PL-RS) for an uplink channel. The method further includes updating the target TCI state or using the reference signal as the PL-RS for the uplink channel based on one or more parameters associated with receiving the reference signal and further based on expiration of an activation delay interval. The activation delay interval is associated with the message and occurs after the threshold time period.

Another innovative aspect of the subject matter described in this disclosure can be implemented in a UE that includes at least one processor and a memory coupled with the at least one processor. The memory stores processor-readable code that, when executed by the at least one processor, is configured to receive a reference signal and to receive a message within a threshold time period after receiving the reference signal. The message indicates an update to a TCI state for the UE or indicates that the UE is to use the reference signal as a PL-RS for an uplink channel. The processor-readable code is further executable by the at least one processor to update the target TCI state or use the reference signal as the PL-RS for the uplink channel based on one or more parameters associated with receiving the reference signal and further based on expiration of an activation delay interval. The activation delay interval is associated with the message and occurs after the threshold time period.

Another innovative aspect of the subject matter described in this disclosure can be implemented in a method for wireless communication performed by a base station. The method includes transmitting a reference signal and transmitting a message within a threshold time period after transmitting the reference signal. The message indicates an update to a target TCI state for a UE or indicates that the UE is to use the reference signal as a PL-RS for an uplink channel. The method further includes communicating with the UE based on the target TCI state or based on the reference signal as the PL-RS and further based on expiration of an activation delay interval. The activation delay interval is associated with the message and occurs after the threshold time period.

Another innovative aspect of the subject matter described in this disclosure can be implemented in a base station. The base station includes at least one processor and a memory coupled with the at least one processor and storing processor-readable code that, when executed by the at least one processor, is configured to transmit a reference signal and to transmit a message within a threshold time period after transmitting the reference signal. The message indicates an update to a target TCI state for a UE or indicates that the UE is to use the reference signal as a PL-RS for an uplink channel. The processor-readable code is further executable by the at least one processor to communicate with the UE based on the target TCI state or based on the reference signal as the PL-RS and further based on expiration of an activation delay interval. The activation delay interval is associated with the message and occurs after the threshold time period.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports updating a transmission configuration indicator (TCI) state or changing a path loss reference signal (PL-RS) according to one or more aspects.

FIG. 4 is a timing diagram illustrating a first set of operations and a second set of operations that may be performed within the wireless communication system of FIG. 3 to support updating a TCI state or changing a PL-RS according to one or more aspects.

FIG. 5 is a flow diagram illustrating an example process performed by a UE that supports updating a TCI state or changing a PL-RS according to one or more aspects.

FIG. 6 is a flow diagram illustrating an example process performed by a base station that supports updating a TCI state or changing a PL-RS according to one or more aspects.

FIG. 7 is a block diagram of an example UE that supports updating a TCI state or changing a PL-RS according to one or more aspects.

FIG. 8 is a block diagram of an example base station that supports updating a TCI state or changing a PL-RS according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatus, methods, and computer-readable media for reducing latency associated with performing some operations that use a reference signal. To illustrate, a user equipment (UE) may receive a reference signal and then may receive a message indicating one or more of an update of a transmission configuration indicator (TCI) state of the UE or a change in a designation of a path loss reference signal (PL-RS) measured by the UE. If the reference signal is received within a threshold time period of receiving the message (or vice versa), the UE may perform the update of the TCI state or the change in designation of the PL-RS using one or more parameters determined using the reference signal. In some examples, if the reference signal is received outside the threshold time period of receiving the message (or vice versa), the UE may “wait” for another occasion of the reference signal and may determine the one or more parameters based on receiving the reference signal in the other occasion. For example, the UE may not update the TCI state or change the designation of the PL-RS based on receiving the reference signal and may instead wait for a next or subsequent occasion of the reference signal to measure the one or more parameters. The UE may then update the TCI state or change the designation of the PL-RS based on the one or more parameters measured during the next or subsequent occasion of the reference signal.

Particular implementations of the subject matter described in this disclosure can be implemented to realize one or more of the following potential advantages. In some aspects, the techniques presented herein facilitate reduced latency associated with an update of a TCI state or a change in a designation of a PL-RS. For example, by using one or more parameters determined based on a reference signal received within a threshold time period of receiving a message indicating the update or the change, a UE may avoid waiting for another occasion of the reference signal in some circumstances. In such examples, latency may be reduced as compared to some other techniques that include waiting for a subsequent occasion of the reference signal (after receiving the message) to measure the reference signal. For example, by performing at least some measurements of the reference signal prior to (instead of after) receiving the message, the UE may be ready to perform the update or the change sooner (as compared to some techniques that involve waiting to perform the measurements after receiving the message). As a result, an activation delay interval (or “grace period” during which the UE may prepare to apply the update or the change) may be reduced, which may decrease latency and improve reliability of communication in some circumstances.

This disclosure relates generally to providing or participating in authorized shared access between two or more wireless communication systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunication system (UMTS) mobile phone standard. The 3GPP may define specifications for the next generation of mobile networks, mobile systems, and mobile devices. The present disclosure may describe some aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ˜1M nodes per km\hat{ }2), ultra-low complexity (such as ˜10s of bits per sec), ultra-low energy (such as ˜10+ years of battery life), and deep coverage with the capability to reach challenging locations; (2) including mission-critical control with strong security to safeguard sensitive personal, financial, or classified information, ultra-high reliability (such as ˜99.99999% reliability), ultra-low latency (such as ˜ 1 millisecond (ms)), and users with wide ranges of mobility or lack thereof, and (3) with enhanced mobile broadband including extreme high capacity (such as ˜ 10 Tbps per km\hat{ }2), extreme data rates (such as multi-Gbps rate, 100+Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5GNNR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, some aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communication systems and applications than the particular examples provided.

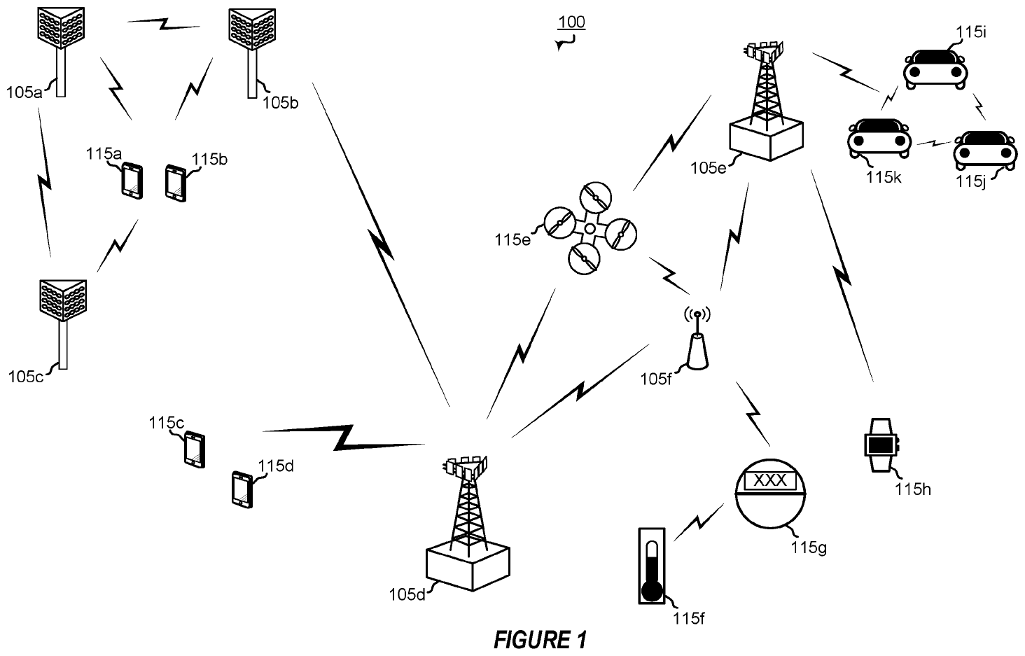

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (CoMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

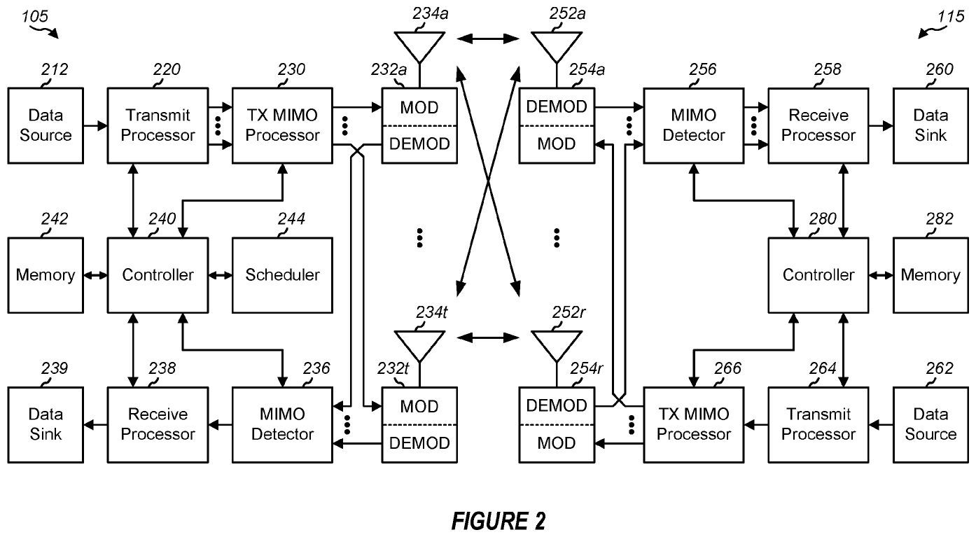

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a controller 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller 240.

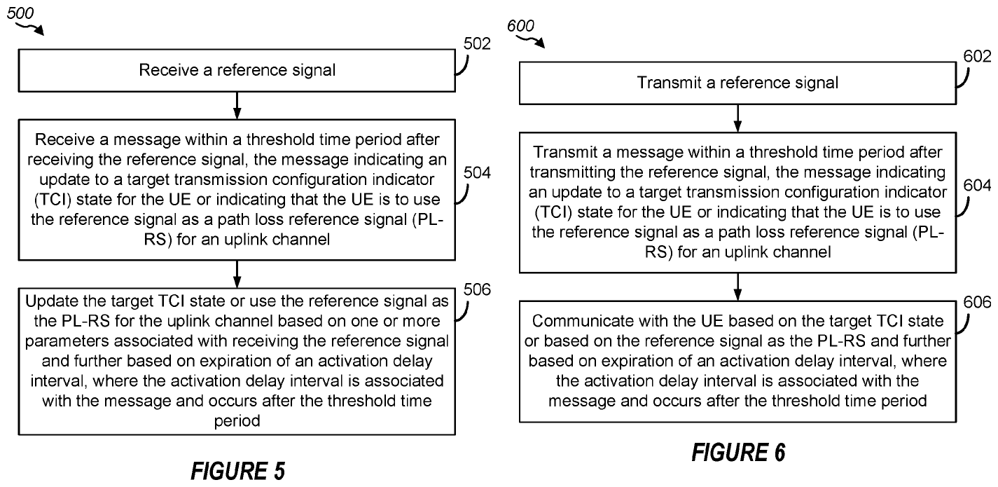

The controllers 240 and 280 may direct the operation at the base station 105 and the UE 115, respectively. The controller 240 or other processors and modules at the base station 105 or the controller 280 or other processors and modules at the UE 115 may perform or direct the execution of various processes for the techniques described herein, such as to perform or direct the execution illustrated in FIGS. 5 and 6, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a particular bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

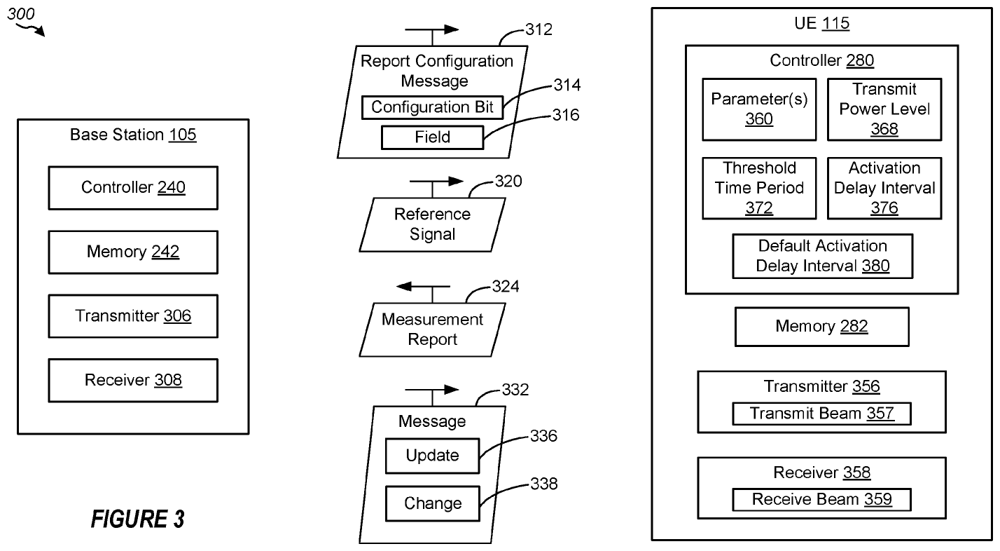

FIG. 3 is a block diagram of an example wireless communication system 300 that supports updating a TCI state or changing a PL-RS according to one or more aspects. In some examples, the wireless communication system 300 may implement aspects of the wireless network 100. The wireless communication system 300 includes the UE 115 and the base station 105. Although one UE 115 and one base station 105 are illustrated, in some other implementations, the wireless communication system 300 may generally include multiple UEs 115, and may include more than one base station 105.

The example of FIG. 3 illustrates that the base station 105 may include one or more processors (such as the controller 240) and may include the memory 242. The base station 105 may further include a transmitter 306 and a receiver 308. The controller 240 may be coupled to the memory 242, to the transmitter 306, and to the receiver 308. In some examples, the transmitter 306 and the receiver 308 include one or more components described with reference to FIG. 2, such as one or more of the modulator/demodulators 232a-t, the MIMO detector 236, the receive processor 238, the transmit processor 220, or the TX MIMO processor 230. In some implementations, the transmitter 306 and the receiver 308 may be integrated in one or more transceivers of the base station 105.

The transmitter 306 may be configured to transmit reference signals, synchronization signals, control information, and data to one or more other devices, and the receiver 308 may be configured to receive reference signals, control information, and data from one or more other devices. For example, the transmitter 306 may be configured to transmit signaling, control information, and data to the UE 115, and the receiver 308 may be configured to receive signaling, control information, and data from the UE 115.

FIG. 3 also illustrates that the UE 115 may include one or more processors (such as the controller 280), a memory (such as the memory 282), a transmitter 356, and a receiver 358. The controller 280 may be coupled to the memory 282, to the transmitter 356, and to the receiver 358. In some examples, the transmitter 356 and the receiver 358 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356 and the receiver 358 may be integrated in one or more transceivers of the UE 115.

The transmitter 356 may be configured to transmit reference signals, synchronization signals, control information, and data to one or more other devices, and the receiver 358 may be configured to receive reference signals, control information, and data from one or more other devices. For example, in some implementations, the transmitter 356 may be configured to transmit signaling, control information, and data to the base station 105, and the receiver 358 may be configured to receive signaling, control information, and data from the base station 105.

In some implementations, one or more of the transmitter 306, the receiver 308, the transmitter 356, or the receiver 358 may include an antenna array. The antenna array may include multiple antenna elements that perform wireless communications with other devices. In some implementations, the antenna array may perform wireless communications using different beams, also referred to as antenna beams. The beams may include transmit beams and receive beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. In some implementations, one or more sets of antenna elements of the antenna array may be configured to concurrently generate multiple beams, for example using multiple RF chains. A set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, the wireless communication system 300 operates in accordance with a 5G NR network. For example, the wireless communication system 300 may include multiple 5G-capable UEs 115 and multiple 5G-capable base stations 105, such as UEs and base stations configured to operate in accordance with a 5G NR network protocol such as that defined by the 3GPP.

During operation, the base station 105 may transmit a reference signal 320. In some examples, the reference signal 320 includes or corresponds to a channel state information reference signal (CSI-RS) or a synchronization signal block (SSB), as illustrative examples.

The UE 115 may receive the reference signal 320 and may determine one or more parameters 360 based on the reference signal 320. To illustrate, the UE 115 may perform one or more measurements based on the reference signal 320 (such as by measuring one or more properties associated with the reference signal 320), and the one or more parameters 360 may include or may be based on the one or more measurements. To further illustrate, the one or more parameters 360 may include one or more of a reference signal received power (RSRP) measurement, a signal-to-interference-plus-noise ratio (SINR) measurement, a precoding matrix indicator (PMI), a rank indicator (RI), a Doppler shift, a Doppler Spread, an average delay, a delay spread, or a path loss characteristic, as illustrative examples.

After transmitting the reference signal 320, the base station 105 may transmit a message 332 to the UE 115. In some examples, the message 332 includes or corresponds to a medium access control (MAC) control element (MAC-CE). The message 332 may indicate an update 336 associated with the UE 115 based on the reference signal 320. For example, the update 336 may be associated with (or may indicate) a target transmission configuration indicator (TCI) state for the UE 115. To illustrate, the reference signal 320 may have a quasi-colocation (QCL) relation with the target TCI state, such as a QCL type A relation or a QCL type B relation with the target TCI state. In this case, the UE 115 may “re-use” some measurements or parameters determined based on the reference signal 320 in connection with another transmission. Alternatively, or in addition, the message 332 may indicate a change 338 in a designation of a path loss reference signal (PL-RS) associated with the UE 115. For example, the message 332 may indicate that the UE 115 is to use the reference signal 320 as a PL-RS associated with an uplink channel.

In some aspects of the disclosure, the UE 115 determines whether the reference signal 320 is received within a threshold time period 372 associated with the message 332. If the reference signal 320 is received within the threshold time period 372, then the UE 115 may use the one or more parameters 360 in connection with the update 336 or the change 338. Further, use of the one or more parameters 360 may enable the UE 115 to apply the update 336 or the change 338 earlier as compared to some other examples in which the UE 115 may wait for another reference signal after receiving the message 332. For example, use of the one or more parameters 360 may enable the UE 115 to apply the update 336 or the change 338 within an activation delay interval 376. Upon expiration of the activation delay interval 376, the base station 105 and the UE 115 may “agree” that the update 336 or the change 338 has been applied (such as by changing a beam based on the target TCI state or by using the reference signal 320 as the PL-RS).

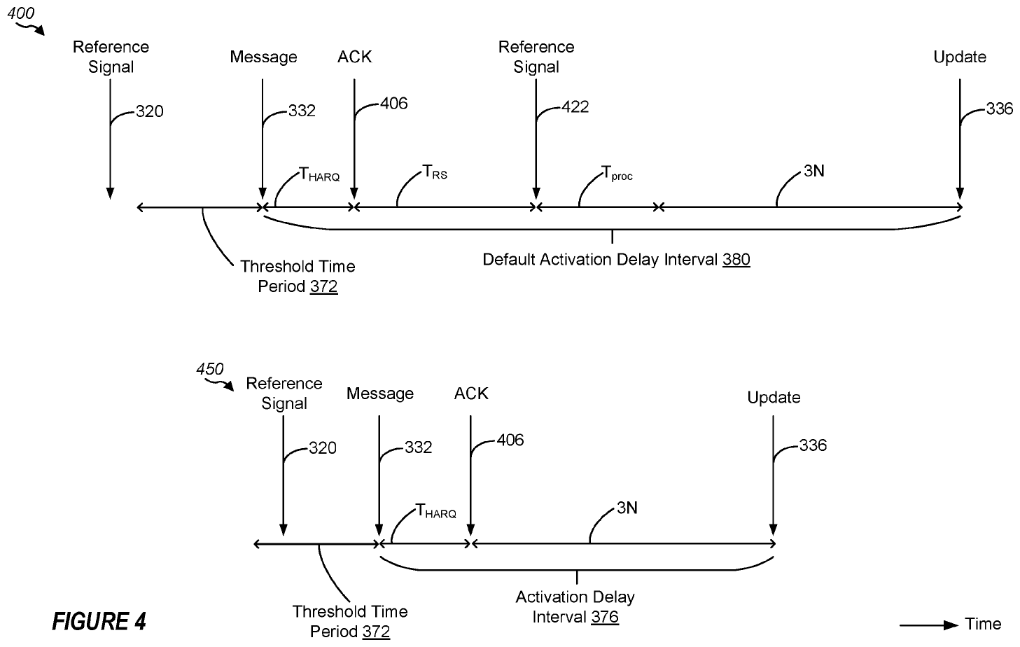

In some other examples, the reference signal 320 may be received outside the threshold time period 372. In this case, the UE 115 may wait to receive a second reference signal after receiving the message 332 and may apply the update 336 or the change 338 based on the second reference signal. In such examples, the base station 105 and the UE 115 may use a longer delay interval than the activation delay interval 376 (such as a “default” delay interval 380) for applying the update 336 or the change 338, which may enable the UE 115 to measure one or more other parameters during a subsequent occasion of the reference signal 320 (or another reference signal). Some illustrative examples of the threshold time period 372 and the activation delay interval 376 are described further below with reference to FIG. 4.

Based on determining that the reference signal 320 is received within the threshold time period 372, the UE 115 may apply the update 336 or the change 338 based on the one or more parameters 360 and further based on expiration of the activation delay interval 376. In some examples, applying the update 336 may include adjusting a receive beam 359 of the UE 115 based on the one or more parameters 360 and the target TCI state (such as based on one or more of a Doppler shift, a Doppler Spread, an average delay, or a delay spread indicated by the one or more parameters 360), and the UE 115 may receive a downlink transmission from the base station 105 using the receive beam 359. Alternatively, or in addition, applying the update 336 may include adjusting a transmit beam 357 of the UE 115 based on the one or more parameters 360 and the target TCI state (such as based on one or more of a Doppler shift, a Doppler Spread, an average delay, or a delay spread indicated by the one or more parameters 360), and the UE 115 may transmit an uplink transmission to the base station 105 using the transmit beam 357.

Alternatively, or in addition, the UE 115 may perform the change 338 of the designation of the PL-RS, and the one or more parameters 360 may include a path loss characteristic associated with an uplink channel based on the PL-RS. To illustrate, the change 338 may modify the designation of a PL-RS, such as by changing the designation of the PL-RS from another reference signal to the reference signal 320. In some examples, the change 338 may cause the UE 115 to track the reference signal 320 as the PL-RS alternatively or in addition to tracking the other signal as the PL-RS. The UE 115 may estimate a path loss characteristic associated with the uplink channel based on the reference signal 320. The UE 115 may determine a transmit power level 368 associated with an uplink transmission based on the path loss characteristic that is measured using the designated PL-RS. For example, the UE 115 may increase (or decrease) the transmit power level 368 for a greater (or smaller) path loss characteristic. In such examples, applying the change 338 may include setting the transmit power level 368 based on the path loss characteristic that is measured using the designated PL-RS. The UE 115 may transmit the uplink transmission via the uplink channel based on the transmit power level 368 (such as using the transmit beam 357).

Further, the base station 105 may communicate with the UE 115 based on expiration of the activation delay interval 376. For example, communicating with the UE 115 may include adjusting a transmit beam of the base station 105 based on the target TCI state and transmitting a downlink transmission to the UE 115 using the transmit beam. Alternatively or in addition, communicating with the UE 115 may include adjusting a receive beam of the base station 105 based on the target TCI state and receiving an uplink transmission from the UE 115 using the receive beam. Alternatively or in addition, communicating with the UE 115 may include receiving an uplink transmission from the UE 115 having the transmit power level 368 based on a path loss characteristic that is determined using the reference signal 320 as the PL-RS.

In some examples, if the UE 115 has not measured and reported the reference signal 320 within the threshold time period 372 prior to receiving the message 332, the UE 115 may perform one or more measurements of the reference signal 320 during the default activation delay interval 380 (such as by “waiting” for one or more subsequent occasions of the reference signal 320 and by performing M measurements of the reference signal 320 during the default activation delay interval 380, where M>0). In some other examples, if the UE 115 has performed N measurements of the reference signal 320 within the threshold time period 372 prior to receiving the message 332 (where N>0), the UE 115 may perform fewer measurements of the reference signal 320 during the activation delay interval 376. For example, the UE 115 may perform L measurements of the reference signal 320 during the activation delay interval 376, where L+N=M, as an illustrative example.

In some implementations, the UE 115 may optionally avoid receiving and measuring some transmissions of the reference signal 320. For example, in some wireless communication protocols, some transmissions of a CSI-RS or an SSB may not trigger the UE 115 to transmit a measurement report, in which case the UE 115 may decline to receive and measure the reference signal 320. As another example, in some wireless communication protocols, the UE 115 may operate according to a particular mode (such as a discontinuous reception (DRX) mode) in which one or more components of the UE 115 (such as the receiver 358) are in a sleep state or low-power state. In such examples, the base station 105 may be unaware whether the UE 115 has received and measured the reference signal 320 (and may be unaware whether to use the activation delay interval 376 or the default activation delay interval 380 that is longer than the activation delay interval 376.

In some implementations, to enable the base station 105 to determine whether the UE 115 has received and measured the reference signal 320, the UE 115 may transmit a measurement report 324 to the base station 105 based on the reference signal 320. The measurement report 324 may include at least one parameter of the one or more parameters 360, such as an RSRP measurement, an SINR measurement, a PMI, or an RI, as illustrative examples. Depending on the particular implementation, the UE 115 may transmit the measurement report 324 periodically, semi-persistently, or non-periodically. Further, the UE 115 may transmit the measurement report 324 based on at least one resource associated with the reference signal 320 having a QCL relation with the target TCI state that may be indicated by the message 332. In some implementations, the measurement report 324 corresponds to a channel state information (CSI) report or a beam measurement report.

In some examples, the base station 105 and the UE 115 may use the activation delay interval 376 based on the transmission of the measurement report 324. In some other examples, if the UE 115 fails to transmit the measurement report 324 (such as in cases where the UE 115 does not receive and measure the reference signal 320), then the base station 105 and the UE 115 may use the default activation delay interval 380.

In some wireless communication protocols, the base station 105 may transmit a report configuration message 312 to the UE 115. The report configuration message 312 may indicate one or more characteristics associated with the measurement report 324. For example, the report configuration message 312 may include a configuration bit 314 (such as a report metric) and a field 316. A value of the configuration bit 314 may indicate whether the reference signal 320 is to trigger the transmission of the measurement report 324. For example, the value may correspond to one of a first value (such as a logic one value) indicating that the reference signal 320 is to trigger the transmission of the measurement report 324 or a second value (such as a logic zero value) indicating that reporting is not requested. The field 316 may indicate at least one parameter of the one or more parameters 360 to include in the measurement report 324 (such as an RSRP measurement, an SINR measurement, a PMI, or an RI, as illustrative examples). The measurement report 324 may include the at least one parameter based on the value of the configuration bit 314 indicating that the reference signal 320 is to trigger the transmission of the measurement report 324.

To further illustrate, in some implementations, one or more features of the reference signal 320 may “disqualify” the one or more parameters 360 from being used in connection with the update 336 or the change 338. In such examples, the base station 105 and the UE 115 may use the default activation delay interval 380 (instead of the activation delay interval 376) in connection with the update 336 or the change 338, which may enable the UE 115 to measure one or more other parameters during a subsequent occasion of the reference signal 320 (or another reference signal).

For example, if the reference signal 320 is associated with one or both of a non-reporting mode or a repetition mode, then the one or more parameters 360 may be “disqualified” from being used in connection with the update 336 or the change 338. In such examples, the UE 115 may receive the reference signal 320 in connection with a procedure three (P3) receive beam refinement process, which may fail to trigger transmission of the measurement report 324 (in which case the base station 105 may be unable to determine whether the UE 115 has received and measured the reference signal 320).

In some other examples, the reference signal 320 may be associated with one or both of a reporting mode or a non-repetition mode, and the one or more parameters 360 may be used in connection with the update 336 or the change 338. In such examples, the UE 115 may receive the reference signal 320 in connection with a procedure one (P1) beam selection process or a procedure two (P2) transmit beam refinement process, which may trigger transmission of the measurement report 324 (enabling the base station 105 to detect that the UE 115 has received and measured the reference signal 320).

In some examples, the base station 105 and the UE 115 communicate based on a wireless communication protocol that specifies the threshold time period 372. In some other examples, the base station 105 may determine the threshold time period 372 and may configure the UE 115 with the threshold time period 372. In some other examples, the UE 115 may indicate the threshold time period 372 to the base station 105 or one or more characteristics of the UE 115 (such as a mobility or capability of the UE 115), and the base station 105 may determine the threshold time period 372 based on the indication or the one or more characteristics. As an illustrative example, the capability may correspond to or may be based on a storage capacity of the UE 115 to store the one or more parameters 360 (such as at the memory 282) after transmission of the measurement report 324. In such examples, the UE 115 may signal the threshold time period 372 to the base station 105 based on a capability of the UE 115 to store the one or more parameters 360. The base station 105 may configure the UE 115 with the threshold time period 372 based on the capability indicated by the UE 115.

Alternatively or in addition, the UE 115 may indicate a mobility associated with the UE 115 to the base station 105 or may determine the threshold time period 372 based on the mobility associated with the UE 115. To illustrate, the UE 115 may use one or more sensors (such as one or more of a position sensor, an acceleration sensor, or another sensor) to determine the mobility, which may correspond to a change in position or velocity associated with the UE 115 or a Doppler frequency associated with the UE 115 (which may be based on the velocity associated with the UE 115). For a greater mobility of the UE 115, beams may change more rapidly (as compared to a smaller mobility), in which case the UE 115 or the base station 105 may determine a smaller threshold time period 372 (which may reduce or avoid instances of “stale” measurements in cases of relatively high mobility). For a smaller mobility of the UE 115, beams may change less rapidly, in which case the UE 115 or the base station 105 may determine a greater (or “relaxed”) threshold time period 372.

In some examples, the threshold time period 372 may be based on one or more parameters specified by a wireless communication protocol. For example, some wireless communication protocols may specify a TCI activation time for the UE 115 to activate the target TCI state, which may correspond to 1280 milliseconds (ms) in some implementations. In some examples, the threshold time period 372 may be less than the TCI activation time associated with the target TCI state.

Further, the threshold time period 372 may correspond to a number of seconds, a number of slots, or a number of slots as a function of a subcarrier spacing (SCS) value. To illustrate, the base station 105 may specify the threshold time period 372 to the UE 115 (or vice versa) by indicating a number of seconds, a number of slots, or a number of slots as a function of an SCS value.

Particular examples have been described above with reference to an “implicit” determination that the UE 115 receives and measures the reference signal 320. For example, by transmitting the measurement report 324 indicating at least one parameter of the one or more parameters 360, the base station 105 may determine, without use of explicit signaling, that the UE 115 has receive and measured the reference signal 320. Alternatively or in addition to use of the measurement report 324, the base station 105 may transmit a command or request to the UE 115 indicating that the UE is to receive and measure the reference signal 320. The command or request may specify one or more SSBs or CSI-RSs for the UE 115 to track, which may include or correspond to the reference signal 320.

Alternatively or in addition, the UE 115 may transmit to the base station 105 an indication that the UE 115 is to track the reference signal 320 (such as by determining the one or more parameters 360 based on the reference signal 320). As an example, the indication may specify one or more slots during which the UE 115 is to receive the reference signal 320. The indication may recommend one or more TCI states, and the base station 105 may determine the target TCI state based on the recommendation from the UE 115.

In some examples, the base station 105 may specify a time duration during which the UE 115 is to track the reference signal 320. For example, the base station 105 may transmit second message indicating a time duration during which the UE 115 is to track the reference signal 320. Further, the base station 105 may update the reference signal 320, such as by designating a different reference signal for tracking by the UE 115 (such as by adjusting from a CSI-RS to an SSB, or vice versa). In such examples, the base station 105 may transmit one or more third messages indicating an update of the reference signal 320.

FIG. 4 is a timing diagram illustrating a first set of operations 400 and a second set of operations 450 that may be performed within the wireless communication system 300 of FIG. 3 to support updating a TCI state or changing a PL-RS according to one or more aspects. The operations 400 and 450 may be performed by the base station 105 and the UE 115.

In the first set of operations 400, the base station 105 may transmit the reference signal 320, and the UE 115 may receive the reference signal 320. For example, the UE 115 may perform a scan to measure the reference signal 320 and to determine the one or more parameters 360.

The base station 105 may transmit the message 332, and the UE 115 may receive the message 332. In the example of FIG. 4, the UE 115 may receive the reference signal 320 outside the threshold time period 372.

The UE 115 may transmit an acknowledgement (ACK) 406 of the message 332 to the base station 105 after a hybrid automatic repeat request (HARQ) time interval THARQ. The UE 115 may receive a second reference signal 422 after a reference signal time interval TRS. The UE 115 may process the second reference signal 422 during a processing time interval Tproc and may apply the update 336 or the change 338 after a time interval 3N.

Because the UE 115 receives the reference signal 320 outside the threshold time period 372 in the first set of operations 400, the UE 115 may perform the update 336 or the change 338 based on the default activation delay interval 380 (instead of the activation delay interval 376). During the default activation delay interval 380, the UE 115 may receive and measure the second reference signal 422. The UE 115 may perform the update 336 or the change 338 upon expiration of the default activation delay interval 380 based on one or more parameters determined based on the second reference signal 422. In some examples, the duration of the default activation delay interval 380 may be determined according to THARQ+3N+TOk*(TRS+Tproc)/slot length, where TOk=1.

In the second set of operations 450, the UE 115 may receive the reference signal 320 within the threshold time period 372. As a result, the UE 115 may apply the update 336 or the change 338 based on the activation delay interval 376 (instead of the default activation delay interval 380). In some examples, the UE 115 sets TOk=0 based on determining that the reference signal 320 is received within the threshold time period 372. In such examples, the duration of the activation delay interval 376 may be determined according to THARQ+3N.

Although the example of FIG. 4 illustrates that expiration of the threshold time period 372 may be based on reception of the message 332, other examples are also within the scope of the disclosure. For example, in some implementations, expiration of the threshold time period 372 may be based on transmission of the ACK 406. In some other examples, expiration of the threshold time period 372 may be based on an end of a MAC-CE activation time, which may correspond to expiration of the time interval 3N.

One or more aspects described herein may improve performance of a wireless communication system, such as by reducing latency associated with an update of a TCI state or a change in designation of a PL-RS. For example, by using the one or more parameters 360 determined based on the reference signal 320 received within the threshold time period 372, the UE 115 may avoid waiting for another occasion of the reference signal, such as the second reference signal 422. As a result, an activation delay interval associated with applying the update or the change may be reduced (such as by using the activation delay interval 376 instead of the default activation delay interval 380), which may decrease latency and improve reliability of communication in some circumstances.

FIG. 5 is a flow diagram illustrating an example process 500 performed by a UE that supports updating a TCI state or changing a PL-RS according to one or more aspects. Operations of the process 500 may be performed by a UE, such as the UE 115.

In block 502, the UE receives a reference signal. For example, the UE 115 may receive the reference signal 320 from the base station 105.

In block 504, the UE receives a message within a threshold time period after receiving the reference signal. The message indicates an update to a target TCI state for the UE or indicates that the UE is to use the reference signal as a PL-RS for an uplink channel. For example, the UE 115 may receive the message 332 within the threshold time period 372. The message 332 may indicate an update to a target TCI state for the UE 115 or may indicate to use the reference signal 320 as a PL-RS for an uplink channel.

In block 506, the UE updates the target TCI state or uses the reference signal as the PL-RS for the uplink channel based on one or more parameters associated with receiving the reference signal and further based on expiration of an activation delay interval. The activation delay interval is associated with the message and occurs after the threshold time period. For example, the UE 115 may update the target TCI state or use the reference signal 320 as the PL-RS based on the one or more parameters 360 associated with receiving the reference signal 320 and further based on expiration of the activation delay interval 376.

FIG. 6 is a flow diagram illustrating an example process 600 performed by a base station that supports updating a TCI state or changing a PL-RS according to one or more aspects. Operations of the process 600 may be performed by a base station, such as the base station 105.

In block 602, the base station transmits a reference signal. For example, the base station 105 may transmit the reference signal 320 to the UE 115.

In block 604, the base station transmits a message within a threshold time period after transmitting the reference signal. The message indicates an update to a target TCI state for a UE or indicates that the UE is to use the reference signal as a PL-RS for an uplink channel. For example, the base station 105 may transmit the message 332 within the threshold time period 372. The message 332 may indicate an update to a target TCI state for the UE 115 or may indicate to use the reference signal 320 as a PL-RS for an uplink channel.

In block 606, the base station communicates with the UE based on the target TCI state or based on the reference signal as the PL-RS and further based on expiration of an activation delay interval. The activation delay interval is associated with the message and occurs after the threshold time period. For example, the base station 105 may communicate with the UE 115 based on the target TCI state or based on the reference signal 320 and further based on expiration of the activation delay interval 376.

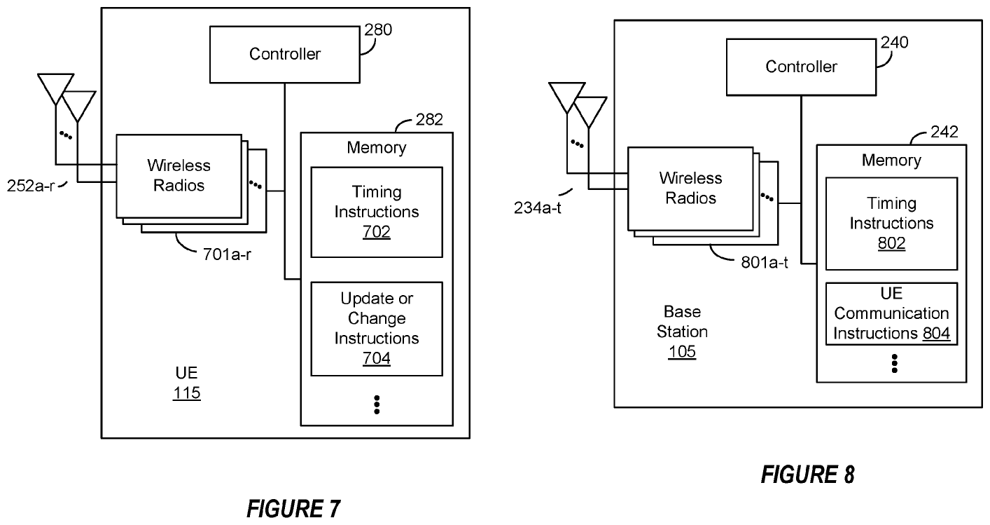

FIG. 7 is a block diagram of an example UE 115 that supports updating a TCI state or changing a PL-RS according to one or more aspects. The UE 115 may be configured to perform one or more operations described herein, including the blocks of the process 500 described with reference to FIG. 5. In some implementations, the UE 115 includes the structure, hardware, and components shown and described with reference to the UE 115 of FIGS. 2 or 3. For example, the UE 115 includes the controller 280, which operates to execute logic or computer instructions stored in the memory 282, as well as controlling the components of the UE 115 that provide the features and functionality of the UE 115. The UE 115, under control of the controller 280, transmits and receives signals via wireless radios 701a-r and the antennas 252a-r. The wireless radios 701a-r include various components and hardware, such as the modulator and demodulators 254a-r, the MIMO detector 256, the receive processor 258, the transmit processor 264, the TX MIMO processor 266, the transmitter 356, the receiver 358, one or more other components, or a combination thereof.

The memory 282 may store instructions executable by at least one processor (such as the controller 280) to initiate, perform, one or control one or more operations described herein. For example, the memory 282 may store timing instructions 702 executable by the controller 280 to determine whether the message 332 is received within the threshold time period 372 of receiving the reference signal 320 and to detect expiration of the activation delay interval 376. In response to determining that the message 332 is received within the threshold time period 372 of receiving the reference signal 320, the controller 280 may execute update or change instructions 704 to update the target TCI state or use the reference signal 320 as the PL-RS based on the one or more parameters 360 associated with receiving the reference signal 320 and further based on expiration of the activation delay interval 376.

FIG. 8 is a block diagram of an example base station 105 that supports updating a TCI state or changing a PL-RS according to one or more aspects. The base station 105 may be configured to one or more operations described herein, including the blocks of the process 500 described with reference to FIG. 5. In some implementations, the base station 105 includes the structure, hardware, and components shown and described with reference to the base station 105 of FIGS. 1-3. For example, the base station 105 may include the controller 240, which operates to execute logic or computer instructions stored in the memory 242, as well as controlling the components of the base station 105 that provide the features and functionality of the base station 105. The base station 105, under control of the controller 240, transmits and receives signals via wireless radios 801a-t and the antennas 234a-t. The wireless radios 801a-t include various components and hardware, such as the modulator and demodulators 232a-t, the transmit processor 220, the TX MIMO processor 230, the MIMO detector 236, the receive processor 238, the transmitter 306, the receiver 308, one or more other components, or a combination thereof.

The memory 242 may store instructions executable by at least one processor (such as the controller 240) to initiate, perform, one or control one or more operations described herein. For example, the memory 242 may store timing instructions 802 executable by the controller 240 to determine whether the message 332 is transmitted within the threshold time period 372 of transmitted the reference signal 320 and to detect expiration of the activation delay interval 376. In response to determining that the message 332 is transmitted within the threshold time period 372 of transmitting the reference signal 320, the controller 240 may execute UE communication instructions 804 to communicate with the UE 115 based on the target TCI state or based on the reference signal as the PL-RS and further based on expiration of the activation delay interval 376.

To further illustrate some aspects, in a first aspect, a method includes receiving a reference signal and receiving a message within a threshold time period after receiving the reference signal. The message indicates an update to a target TCI state for the UE or indicates that the UE is to use the reference signal as a PL-RS for an uplink channel. The method further includes updating the target TCI state or using the reference signal as the PL-RS for the uplink channel based on one or more parameters associated with receiving the reference signal and further based on expiration of an activation delay interval. The activation delay interval is associated with the message and occurs after the threshold time period.

In a second aspect alternatively or in addition to the first aspect, the reference signal includes a CSI-RS or an SSB, and the reference signal has a QCL relation with the target TCI state.

In a third aspect alternatively or in addition to one or more of the first through second aspects, the method includes transmitting a measurement report based on the reference signal, and the activation delay interval is further associated with the transmission of the measurement report.

In a fourth aspect alternatively or in addition to one or more of the first through third aspects, the method includes receiving a report configuration message including a configuration bit and a field. A value of the configuration bit indicates whether the reference signal is to trigger the transmission of the measurement report, and the field indicates at least one parameter of the one or more parameters to include in the measurement report.

In a fifth aspect alternatively or in addition to one or more of the first through fourth aspects, the field indicates one or more of an RSRP measurement, an SINR measurement, a PMI, or an RI, and the value of the configuration bit indicates that the reference signal is to trigger the transmission of the measurement report.

In a sixth aspect alternatively or in addition to one or more of the first through fifth aspects, the reference signal is associated with one or both of a reporting mode or a non-repetition mode.

In a seventh aspect alternatively or in addition to one or more of the first through sixth aspects, the reference signal is received in connection with a P1 beam selection process or a P2 transmit beam refinement process.

In an eighth aspect alternatively or in addition to one or more of the first through seventh aspects, the method includes transmitting a measurement report based on the reference signal. The measurement report is transmitted periodically, semi-persistently, or non-periodically, and the measurement report is based on at least one resource associated with the reference signal having a QCL relation with the target TCI state.

In a ninth aspect alternatively or in addition to one or more of the first through eighth aspects, the measurement report corresponds to a CSI report or a beam measurement report.

In a tenth aspect alternatively or in addition to one or more of the first through ninth aspects, the threshold time period is specified by a wireless communication protocol, is configured by a base station for the UE, or is indicated by the UE to the base station.

In an eleventh aspect alternatively or in addition to one or more of the first through tenth aspects, the threshold time period is indicated by the UE to the base station based on one or more of a capability of the UE to store the one or more parameters or a mobility of the UE.

In a twelfth aspect alternatively or in addition to one or more of the first through eleventh aspects, the threshold time period is less than a TCI activation time associated with the target TCI state.

In a thirteenth aspect alternatively or in addition to one or more of the first through twelfth aspects, the threshold time period corresponds to a number of seconds, a number of slots, or a number of slots as a function of a SCS value.

In a fourteenth aspect alternatively or in addition to one or more of the first through thirteenth aspects, the method includes transmitting an indication that the UE is to determine the one or more parameters based on the reference signal.

In a fifteenth aspect alternatively or in addition to one or more of the first through fourteenth aspects, the method includes receiving a second message indicating a time duration during which the reference signal is to be tracked by the UE.

In a sixteenth aspect alternatively or in addition to one or more of the first through fifteenth aspects, the method includes receiving one or more third messages indicating an update of the reference signal.

In a seventeenth aspect alternatively or in addition to one or more of the first through sixteenth aspects, the message corresponds to a MAC-CE.

In an eighteenth aspect alternatively or in addition to one or more of the first through seventeenth aspects, applying the update includes adjusting a receive beam of the UE based on the one or more parameters and the target TCI state, and the method includes receiving a downlink transmission using the receive beam.

In a nineteenth aspect alternatively or in addition to one or more of the first through eighteenth aspects, applying the update includes adjusting a transmit beam of the UE based on the one or more parameters and the target TCI state, and the method includes transmitting an uplink transmission using the transmit beam.

In a twentieth aspect alternatively or in addition to one or more of the first through nineteenth aspects, the one or more parameters include a path loss characteristic associated with the uplink channel, and the method includes setting a transmit power level associated with an uplink transmission based on the path loss characteristic.

In a twenty-first aspect alternatively or in addition to one or more of the first through twentieth aspects, a UE that includes at least one processor and a memory coupled with the at least one processor. The memory stores processor-readable code that, when executed by the at least one processor, is configured to receive a reference signal and to receive a message within a threshold time period after receiving the reference signal. The message indicates an update to a target TCI state for the UE or indicates that the UE is to use the reference signal as a PL-RS for an uplink channel. The processor-readable code is further executable by the at least one processor to update the target TCI state or use the reference signal as the PL-RS for the uplink channel based on one or more parameters associated with receiving the reference signal and further based on expiration of an activation delay interval. The activation delay interval is associated with the message and occurs after the threshold time period.

In a twenty-second aspect alternatively or in addition to one or more of the first through twenty-first aspects, the reference signal includes a CSI-RS or an SSB, and the reference signal has a QCL relation with the target TCI state.

In a twenty-third aspect alternatively or in addition to one or more of the first through twenty-second aspects, the processor-readable code is further executable by the at least one processor to initiate transmission of a measurement report based on the reference signal, and the activation delay interval is further associated with the transmission of the measurement report.

In a twenty-fourth aspect alternatively or in addition to one or more of the first through twenty-third aspects, the processor-readable code is further executable by the at least one processor to receive a report configuration message including a configuration bit and a field. A value of the configuration bit indicates whether the reference signal is to trigger the transmission of the measurement report, and the field indicates at least one parameter of the one or more parameters to include in the measurement report.

In a twenty-fifth aspect alternatively or in addition to one or more of the first through twenty-fourth aspects, the field indicates one or more of an RSRP measurement, an SINR measurement, a PMI, or an RI, and the value of the configuration bit indicates that the reference signal is to trigger the transmission of the measurement report.

In a twenty-sixth aspect alternatively or in addition to one or more of the first through twenty-fifth aspects, the reference signal is associated with one or both of a reporting mode or a non-repetition mode.

In a twenty-seventh aspect alternatively or in addition to one or more of the first through twenty-sixth aspects, the reference signal is received in connection with a P1 beam selection process or a P2 transmit beam refinement process.

In a twenty-eighth aspect alternatively or in addition to one or more of the first through twenty-seventh aspects, the processor-readable code is further executable by the at least one processor to initiate transmission of a measurement report based on the reference signal. The measurement report is transmitted periodically, semi-persistently, or non-periodically, and the measurement report is based on at least one resource associated with the reference signal having a QCL relation with the target TCI state.

In a twenty-ninth aspect alternatively or in addition to one or more of the first through twenty-eighth aspects, the measurement report corresponds to a CSI report or a beam measurement report.

In a thirtieth aspect alternatively or in addition to one or more of the first through twenty-ninth aspects, the threshold time period is specified by a wireless communication protocol, is configured by a base station for the UE, or is indicated by the UE to the base station.

In a thirty-first aspect alternatively or in addition to one or more of the first through thirtieth aspects, the threshold time period is indicated by the UE to the base station based on one or more of a capability of the UE to store the one or more parameters or a mobility of the UE.

In a thirty-second aspect alternatively or in addition to one or more of the first through thirty-first aspects, the threshold time period is less than a TCI activation time associated with the target TCI state.

In a thirty-third aspect alternatively or in addition to one or more of the first through thirty-second aspects, the threshold time period corresponds to a number of seconds, a number of slots, or a number of slots as a function of a SCS value.

In a thirty-fourth aspect alternatively or in addition to one or more of the first through thirty-third aspects, the processor-readable code is further executable by the at least one processor to initiate transmission of an indication that the UE is to determine the one or more parameters based on the reference signal.

In a thirty-fifth aspect alternatively or in addition to one or more of the first through thirty-fourth aspects, the processor-readable code is further executable by the at least one processor to receive a second message indicating a time duration during which the reference signal is to be tracked by the UE.

In a thirty-sixth aspect alternatively or in addition to one or more of the first through thirty-fifth aspects, the processor-readable code is further executable by the at least one processor to receive one or more third messages indicating an update of the reference signal.

In a thirty-seventh aspect alternatively or in addition to one or more of the first through thirty-sixth aspects, the message corresponds to a MAC-CE.

In a thirty-eighth aspect alternatively or in addition to one or more of the first through thirty-seventh aspects, the processor-readable code is further executable by the at least one processor to adjust a receive beam of the UE based on the one or more parameters and the target TCI state, and further comprising receiving a downlink transmission using the receive beam.

In a thirty-ninth aspect alternatively or in addition to one or more of the first through thirty-eighth aspects, the processor-readable code is further executable by the at least one processor to adjust a transmit beam of the UE based on the one or more parameters and the target TCI state, and the method includes transmitting an uplink transmission using the transmit beam.

In a fortieth aspect alternatively or in addition to one or more of the first through thirty-ninth aspects, the one or more parameters include a path loss characteristic associated with the uplink channel, and the processor-readable code is further executable by the at least one processor to set a transmit power level associated with an uplink transmission based on the path loss characteristic.

In a forty-first aspect alternatively or in addition to one or more of the first through fortieth aspects, a method includes transmitting a reference signal and transmitting a message within a threshold time period after transmitting the reference signal. The message indicates an update to a target TCI state for a UE or indicates that the UE is to use the reference signal as a PL-RS for an uplink channel. The method further includes communicating with the UE based on the target TCI state or based on the reference signal as the PL-RS and further based on expiration of an activation delay interval. The activation delay interval is associated with the message and occurs after the threshold time period.

In a forty-second aspect alternatively or in addition to one or more of the first through forty-first aspects, the reference signal includes a CSI-RS or an SSB, and the reference signal has a QCL relation with the target TCI state.

In a forty-third aspect alternatively or in addition to one or more of the first through forty-second aspects, the method includes receiving a measurement report based on the reference signal, and the activation delay interval is further associated with the transmission of the measurement report.

In a forty-fourth aspect alternatively or in addition to one or more of the first through forty-third aspects, the method includes transmitting a report configuration message including a configuration bit and a field. A value of the configuration bit indicates whether the reference signal is to trigger the transmission of the measurement report, and the field indicates at least one parameter to include in the measurement report.

In a forty-fifth aspect alternatively or in addition to one or more of the first through forty-fifth aspects, the field indicates one or more of an RSRP measurement, an SINR measurement, a PMI, or an RI, and the value of the configuration bit indicates that the reference signal is to trigger the transmission of the measurement report.

In a forty-sixth aspect alternatively or in addition to one or more of the first through forty-fifth aspects, the reference signal is associated with one or both of a reporting mode or a non-repetition mode.

In a forty-seventh aspect alternatively or in addition to one or more of the first through forty-sixth aspects, the reference signal is transmitted in connection with a P1 beam selection process or a P2 transmit beam refinement process.

In a forty-eighth aspect alternatively or in addition to one or more of the first through forty-seventh aspects, the method includes receiving a measurement report based on the reference signal. The measurement report is received periodically, semi-persistently, or non-periodically, and the measurement report is based on at least one resource associated with the reference signal having a QCL relation with the target TCI state.

In a forty-ninth aspect alternatively or in addition to one or more of the first through forty-eighth aspects, the measurement report corresponds to a CSI report or a beam measurement report.

In a fiftieth aspect alternatively or in addition to one or more of the first through forty-ninth aspects, the threshold time period is specified by a wireless communication protocol, is configured by the base station for the UE, or is indicated by the UE to the base station.

In a fifty-first aspect alternatively or in addition to one or more of the first through fiftieth aspects, the threshold time period is indicated by the UE to the base station based on one or more of a capability of the UE to store one or more parameters or a mobility of the UE.

In a fifty-second aspect alternatively or in addition to one or more of the first through fifty-first aspects, the threshold time period is less than a TCI activation time associated with the target TCI state.

In a fifty-third aspect alternatively or in addition to one or more of the first through fifty-second aspects, the threshold time period corresponds to a number of seconds, a number of slots, or a number of slots as a function of a SCS value.

In a fifty-fourth aspect alternatively or in addition to one or more of the first through fifty-third aspects, the method includes receiving an indication that the UE is to determine one or more parameters based on the reference signal.

In a fifty-fifth aspect alternatively or in addition to one or more of the first through fifty-fourth aspects, the method includes transmitting a second message indicating a time duration during which the reference signal is to be tracked by the UE.

In a fifty-sixth aspect alternatively or in addition to one or more of the first through fifty-fifth aspects, the method includes transmitting one or more third messages indicating an update of the reference signal.

In a fifty-seventh aspect alternatively or in addition to one or more of the first through fifty-sixth aspects, the message corresponds to a MAC-CE.

In a fifty-eighth aspect alternatively or in addition to one or more of the first through fifty-seventh aspects, communicating with the UE includes adjusting a transmit beam of the base station based on the target TCI state and transmitting a downlink transmission using the transmit beam.

In a fifty-ninth aspect alternatively or in addition to one or more of the first through fifty-eighth aspects, communicating with the UE includes adjusting a receive beam of the base station based on the target TCI state and receiving an uplink transmission using the receive beam.

In a sixtieth aspect alternatively or in addition to one or more of the first through fifty-ninth aspects, communicating with the UE includes receiving an uplink transmission having a transmit power level based on a path loss characteristic that is determined using the reference signal as the PL-RS.

In a sixty-first aspect alternatively or in addition to one or more of the first through sixtieth aspects, a base station includes at least one processor and a memory coupled with the at least one processor and storing processor-readable code that, when executed by the at least one processor, is configured to transmit a reference signal and to transmit a message within a threshold time period after transmitting the reference signal. The message indicates an update to a target TCI state for a UE or indicates that the UE is to use the reference signal as a PL-RS for an uplink channel. The processor-readable code is further executable by the at least one processor to communicate with the UE based on the target TCI state or based on the reference signal as the PL-RS and further based on expiration of an activation delay interval. The activation delay interval is associated with the message and occurs after the threshold time period.

In a sixty-second aspect alternatively or in addition to one or more of the first through sixty-first aspects, the reference signal includes a CSI-RS or an SSB, and the reference signal has a QCL relation with the target TCI state.

In a sixty-third aspect alternatively or in addition to one or more of the first through sixty-second aspects, the processor-readable code is further executable by the at least one processor to receive a measurement report based on the reference signal, and the activation delay interval is further associated with the transmission of the measurement report.

In a sixty-fourth aspect alternatively or in addition to one or more of the first through sixty-third aspects, the processor-readable code is further executable by the at least one processor to transmit a report configuration message including a configuration bit and a field. A value of the configuration bit indicates whether the reference signal is to trigger the transmission of the measurement report, and the field indicates at least one parameter to include in the measurement report.

In a sixty-fifth aspect alternatively or in addition to one or more of the first through sixty-fourth aspects, the field indicates one or more of an RSRP measurement, an SINR measurement, a PMI, or an RI, and the value of the configuration bit indicates that the reference signal is to trigger the transmission of the measurement report.

In a sixty-sixth aspect alternatively or in addition to one or more of the first through sixty-fifth aspects, the reference signal is associated with one or both of a reporting mode or a non-repetition mode.

In a sixty-seventh aspect alternatively or in addition to one or more of the first through sixty-sixth aspects, the reference signal is transmitted in connection with a P1 beam selection process or a P2 transmit beam refinement process.

In a sixty-eighth aspect alternatively or in addition to one or more of the first through sixty-seventh aspects, the processor-readable code is further executable by the at least one processor to receive a measurement report based on the reference signal. The measurement report is received periodically, semi-persistently, or non-periodically, and the measurement report is based on at least one resource associated with the reference signal having a QCL relation with the target TCI state.

In a sixty-ninth aspect alternatively or in addition to one or more of the first through sixty-eighth aspects, the measurement report corresponds to a CSI report or a beam measurement report.

In a seventieth aspect alternatively or in addition to one or more of the first through sixty-ninth aspects, the threshold time period is specified by a wireless communication protocol, is configured by the base station for the UE, or is indicated by the UE to the base station.

In a seventy-first aspect alternatively or in addition to one or more of the first through seventieth aspects, the threshold time period is indicated by the UE to the base station based on one or more of a capability of the UE to store one or more parameters or a mobility of the UE.

In a seventy-second aspect alternatively or in addition to one or more of the first through seventy-first aspects, the threshold time period is less than a TCI activation time associated with the target TCI state.

In a seventy-third aspect alternatively or in addition to one or more of the first through seventy-second aspects, the threshold time period corresponds to a number of seconds, a number of slots, or a number of slots as a function of a SCS value.

In a seventy-fourth aspect alternatively or in addition to one or more of the first through seventy-third aspects, the processor-readable code is further executable by the at least one processor to receive an indication that the UE is to determine one or more parameters based on the reference signal.

In a seventy-fifth aspect alternatively or in addition to one or more of the first through seventy-fourth aspects, the processor-readable code is further executable by the at least one processor to transmit a second message indicating a time duration during which the reference signal is to be tracked by the UE.

In a seventy-sixth aspect alternatively or in addition to one or more of the first through seventy-fifth aspects, the processor-readable code is further executable by the at least one processor to transmit one or more third messages indicating an update of the reference signal.

In a seventy-seventh aspect alternatively or in addition to one or more of the first through seventy-sixth aspects, the message corresponds to a MAC-CE.

In a seventy-eighth aspect alternatively or in addition to one or more of the first through seventy-seventh aspects, the processor-readable code is further executable by the at least one processor to adjust a transmit beam of the base station based on the target TCI state and to transmit a downlink transmission using the transmit beam.

In a seventy-ninth aspect alternatively or in addition to one or more of the first through seventy-eighth aspects, the processor-readable code is further executable by the at least one processor to adjust a receive beam of the base station based on the target TCI state and to receive an uplink transmission using the receive beam.

In an eightieth aspect alternatively or in addition to one or more of the first through seventy-ninth aspects, the processor-readable code is further executable by the at least one processor to receive an uplink transmission having a transmit power level based on a path loss characteristic that is determined using the reference signal as the PL-RS.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Some features that are described in this specification in the context of separate implementations also can be implemented in combination in a single implementation. Conversely, various features that are described in the context of a single implementation also can be implemented in multiple implementations separately or in any suitable subcombination. Moreover, although some features may be described above as acting in combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for wireless communication performed by a user equipment (UE), the method comprising:
receiving a reference signal;
receiving a message within a threshold time period after receiving the reference signal, the message indicating an update to a target transmission configuration indicator (TCI) state for the UE or indicating that the UE is to use the reference signal as a path loss reference signal (PL-RS) for an uplink channel; and
updating the target TCI state or using the reference signal as the PL-RS for the uplink channel based on one or more parameters associated with receiving the reference signal and further based on expiration of an activation delay interval associated with the message, the activation delay interval occurring after the threshold time period.

2. The method of claim 1, wherein the reference signal includes a channel state information reference signal (CSI-RS) or a synchronization signal block (SSB), and wherein the reference signal has a quasi-colocation (QCL) relation with the target TCI state.

3. The method of claim 1, further comprising transmitting a measurement report based on the reference signal, and wherein the activation delay interval is further associated with the transmission of the measurement report.

4. The method of claim 3, further comprising receiving a report configuration message including a configuration bit and a field, wherein a value of the configuration bit indicates whether the reference signal is to trigger the transmission of the measurement report, and wherein the field indicates at least one parameter of the one or more parameters to include in the measurement report.

5. (canceled)

6. The method of claim 1, wherein the reference signal is associated with one or both of a reporting mode or a non-repetition mode.

7. (canceled)

8. The method of claim 1, further comprising transmitting a measurement report based on the reference signal, wherein the measurement report is transmitted periodically, semi-persistently, or non-periodically, and wherein the measurement report is based on at least one resource associated with the reference signal having a quasi-colocation (QCL) relation with the target TCI state.

9. (canceled)

10. The method of claim 1, wherein the threshold time period is specified by a wireless communication protocol, is configured by a base station for the UE, or is indicated by the UE to the base station.

11. The method of claim 10, wherein the threshold time period is indicated by the UE to the base station based on one or more of a capability of the UE to store the one or more parameters or a mobility of the UE.

12. The method of claim 1, wherein the threshold time period is less than a TCI activation time associated with the target TCI state.

13. The method of claim 1, wherein the threshold time period corresponds to a number of seconds, a number of slots, or a number of slots as a function of a subcarrier spacing (SCS) value.

14. (canceled)

15. The method of claim 1, further comprising receiving a second message indicating a time duration during which the reference signal is to be tracked by the UE.

16. (canceled)

17. The method of claim 1, wherein the message corresponds to a medium access control (MAC) control element (MAC-CE).

18-19. (canceled)

20. The method of claim 1, wherein the one or more parameters include a path loss characteristic associated with the uplink channel, and further comprising setting a transmit power level associated with an uplink transmission based on the path loss characteristic.

21. A user equipment (UE) comprising:
at least one processor; and
a memory coupled with the at least one processor and storing processor-readable code that, when executed by the at least one processor, is configured to:
receive a reference signal;
receive a message within a threshold time period after receiving the reference signal, the message indicating an update to a target transmission configuration indicator (TCI) state for the UE or indicating that the UE is to use the reference signal as a path loss reference signal (PL-RS) for an uplink channel; and
update the target TCI state or use the reference signal as the PL-RS for the uplink channel based on one or more parameters associated with receiving the reference signal and further based on expiration of an activation delay interval associated with the message, the activation delay interval occurring after the threshold time period.

22. The UE of claim 21, wherein the reference signal includes a channel state information reference signal (CSI-RS) or a synchronization signal block (SSB), and wherein the reference signal has a quasi-colocation (QCL) relation with the target TCI state.

23. The UE of claim 21, wherein the processor-readable code is further executable by the at least one processor to initiate transmission of a measurement report based on the reference signal, and wherein the activation delay interval is further associated with the transmission of the measurement report.

24. The UE of claim 23, wherein the processor-readable code is further executable by the at least one processor to receive a report configuration message including a configuration bit and a field, wherein a value of the configuration bit indicates whether the reference signal is to trigger the transmission of the measurement report, and wherein the field indicates at least one parameter of the one or more parameters to include in the measurement report.

25. (canceled)

26. The UE of claim 21, wherein the reference signal is associated with one or both of a reporting mode or a non-repetition mode.

27. (canceled)

28. The UE of claim 21, wherein the processor-readable code is further executable by the at least one processor to initiate transmission of a measurement report based on the reference signal, wherein the measurement report is transmitted periodically, semi-persistently, or non-periodically, and wherein the measurement report is based on at least one resource associated with the reference signal having a quasi-colocation (QCL) relation with the target TCI state.

29. (canceled)

30. The UE of claim 21, wherein the threshold time period is specified by a wireless communication protocol, is configured by a base station for the UE, or is indicated by the UE to the base station.

31. The UE of claim 30, wherein the threshold time period is indicated by the UE to the base station based on one or more of a capability of the UE to store the one or more parameters or a mobility of the UE.

32. The UE of claim 21, wherein the threshold time period is less than a TCI activation time associated with the target TCI state.

33. The UE of claim 21, wherein the threshold time period corresponds to a number of seconds, a number of slots, or a number of slots as a function of a subcarrier spacing (SCS) value.

34. (canceled)

35. The UE of claim 21, wherein the processor-readable code is further executable by the at least one processor to receive a second message indicating a time duration during which the reference signal is to be tracked by the UE.

36. (canceled)

37. The UE of claim 21, wherein the message corresponds to a medium access control (MAC) control element (MAC-CE).

38-39. (canceled)

40. The UE of claim 21, wherein the one or more parameters include a path loss characteristic associated with the uplink channel, and wherein the processor-readable code is further executable by the at least one processor to set a transmit power level associated with an uplink transmission based on the path loss characteristic.

41. A method for wireless communication performed by a base station, the method comprising:
transmitting a reference signal;
transmitting a message within a threshold time period after transmitting the reference signal, the message indicating an update to a target transmission configuration indicator (TCI) state for a user equipment (UE) or indicating that the UE is to use the reference signal as a path loss reference signal (PL-RS) for an uplink channel; and
communicating with the UE based on the target TCI state or based on the reference signal as the PL-RS and further based on expiration of an activation delay interval associated with the message, the activation delay interval occurring after the threshold time period.

42. The method of claim 41, wherein the reference signal includes a channel state information reference signal (CSI-RS) or a synchronization signal block (SSB), and wherein the reference signal has a quasi-colocation (QCL) relation with the target TCI state.

43. The method of claim 41, further comprising receiving a measurement report based on the reference signal, and wherein the activation delay interval is further associated with the transmission of the measurement report.

44. The method of claim 43, further comprising transmitting a report configuration message including a configuration bit and a field, wherein a value of the configuration bit indicates whether the reference signal is to trigger the transmission of the measurement report, and wherein the field indicates at least one parameter to include in the measurement report.

45-60. (canceled)

61. A base station comprising:
at least one processor; and
a memory coupled with the at least one processor and storing processor-readable code that, when executed by the at least one processor, is configured to:
transmit a reference signal;
transmit a message within a threshold time period after transmitting the reference signal, the message indicating an update to a target transmission configuration indicator (TCI) state for a user equipment (UE) or indicating that the UE is to use the reference signal as a path loss reference signal (PL-RS) for an uplink channel; and
communicate with the UE based on the target TCI state or based on the reference signal as the PL-RS and further based on expiration of an activation delay interval associated with the message, the activation delay interval occurring after the threshold time period.

62. The base station of claim 61, wherein the reference signal includes a channel state information reference signal (CSI-RS) or a synchronization signal block (SSB), and wherein the reference signal has a quasi-colocation (QCL) relation with the target TCI state.

63. The base station of claim 61, wherein the processor-readable code is further executable by the at least one processor to receive a measurement report based on the reference signal, and wherein the activation delay interval is further associated with the transmission of the measurement report.

64. The base station of claim 63, wherein the processor-readable code is further executable by the at least one processor to transmit a report configuration message including a configuration bit and a field, wherein a value of the configuration bit indicates whether the reference signal is to trigger the transmission of the measurement report, and wherein the field indicates at least one parameter to include in the measurement report.

65. (canceled)

66. The base station of claim 61, wherein the reference signal is associated with one or both of a reporting mode or a non-repetition mode.

67-80. (canceled)
